(19) United States
(12) Patent Application Publication
(10) Pub. No.: US 2026/0239210 A1
(43) Pub. Date: Aug. 13, 2026

(54) CAPABILITY REPORTING METHOD AND APPARATUS

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 19/155,920

(22) PCT Filed: Feb. 16, 2023
(86) PCT No.: PCT/CN2023/076631

§ 371 Date: Aug. 12, 2025

(51) Int. Cl. H04W 52/02; H04W 72/0446

(52) U.S. Cl. CPC H04W 52/0235; H04W 72/0446

(57) ABSTRACT

A capability reporting method, a terminal, and a network device are provided. The capability reporting method includes: reporting, by a terminal, capability information to a network device, wherein the capability information is related to a low-power wake-up signal. In the present disclosure, the network device can configure the low-power wake-up signal more rationally.

### CROSS REFERENCE TO RELATED APPLICATIONS

The present disclosure is the U.S. national phase application of International Application No. PCT/CN2023/076631, filed on Feb. 16, 2023, the content of which is incorporated herein by reference in its entirety for all purposes.

### TECHNICAL FIELD

The present disclosure relates to the field of communication technology, in particular, to a capability reporting method and apparatus.

### BACKGROUND

In wireless communication systems, a power-saving signal, such as a wake-up signal (WUS) is introduced in the 3rd Generation Partnership Project (3GPP), in order to reduce power consumption of a terminal. The WUS is a low-power detection signal. If the terminal detects the WUS, the main radio (MR) will be turned on. If the WUS is not received or the WUS indicates not to wake up, the terminal can keep the main radio in a sleep state. The WUS plays an important role in waking up the main radio, and thus, how to better receive the wake-up signal is an urgent technical problem that needs to be solved.

### SUMMARY

According to a first aspect, the present disclosure provides a capability reporting method, which includes: reporting, by a terminal, capability information to a network device, wherein the capability information is related to a low-power wake-up signal.

According to a second aspect, the present disclosure provides a capability reporting method, which includes:
receiving, by a network device, capability information sent by a terminal, wherein the capability information is related to a low-power wake-up signal; and sending, by the network device, the low-power wake-up signal to the terminal based on the capability information.

According to a third aspect, the present disclosure provides a terminal, which includes:
a first processor;
and a first memory configured to store executable instructions for the first processor; wherein the first processor is configured to execute the executable instructions to perform the capability reporting method provided in the first aspect of the present disclosure.

According to a fourth aspect, the present disclosure provides a network device, which includes:
a second processor; and
a second memory configured to store executable instructions for the second processor; wherein the second processor is configured to execute the executable instructions to perform the capability reporting method provided in the second aspect of the present disclosure.

According to a fifth aspect, the present disclosure provides a computer-readable storage medium having computer program instructions stored thereon, which when executed by a processor, steps of the capability reporting method provided in the first or second aspect of the present disclosure are executed.

It should be understood that the general description in the above and the detailed description in the following are only illustrative and explanatory, and do not limit the present disclosure.

### BRIEF DESCRIPTION OF THE DRAWINGS

The above and/or additional aspects and advantages of the present disclosure will become apparent and easily understood from the following description of embodiments with reference to the drawings.

FIG. 1 shows an application scenario to which a capability reporting method is applicable according to one or more embodiments of the present disclosure.

FIG. 2 is a flowchart of a capability reporting method according to one or more embodiments of the present disclosure.

FIG. 3 is a flowchart of a capability reporting method according to one or more embodiments of the present disclosure.

FIG. 4 is a flowchart of a capability reporting method according to one or more embodiments of the present disclosure.

FIG. 5 is a schematic diagram of the number of symbols between a first time-domain symbol in a synchronization field of a wake-up signal and a first time-domain symbol in a data field of the wake-up signal according to one or more embodiments of the present disclosure.

FIG. 6 is a schematic diagram of the number of symbols between a first time-domain symbol in a synchronization field of a wake-up signal and a last time-domain symbol in a data field of the wake-up signal according to one or more embodiments of the present disclosure.

FIG. 7 is a schematic diagram of the number of symbols between a last time-domain symbol in a synchronization field of a wake-up signal and a last time-domain symbol in a data field of the wake-up signal according to one or more embodiments of the present disclosure.

FIG. 8 is a schematic diagram of the number of symbols between a last time-domain symbol in a synchronization field of a wake-up signal and a first time-domain symbol in a data field of the wake-up signal according to one or more embodiments of the present disclosure.

FIG. 9 is a schematic diagram of the number of time slots between a time slot where a time-domain symbol in the synchronization field of a wake-up signal is located and a time slot where a time-domain symbol in the data field of the wake-up signal is located according to one or more embodiments of the present disclosure.

FIG. 10 is a flowchart of a capability reporting method according to one or more embodiments of the present disclosure.

FIG. 11 is a flowchart of a capability reporting method according to one or more embodiments of the present disclosure.

FIG. 12 is a flowchart of a capability reporting method according to one or more embodiments of the present disclosure.

FIG. 13 is a flowchart of a capability reporting method according to one or more embodiments of the present disclosure.

FIG. 14 is a flowchart of a capability reporting method according to one or more embodiments of the present disclosure.

FIG. 15 is a flowchart of a capability reporting method according to one or more embodiments of the present disclosure.

FIG. 16 is a flowchart of a capability reporting method according to one or more embodiments of the present disclosure.

FIG. 17 is a flowchart of a capability reporting method according to one or more embodiments of the present disclosure.

FIG. 18 is a flowchart of a capability reporting method according to one or more embodiments of the present disclosure.

FIG. 19 is a flowchart of a capability reporting method according to one or more embodiments of the present disclosure.

FIG. 20 is a flowchart of a capability reporting method according to one or more embodiments of the present disclosure.

FIG. 21 is a block diagram of a capability reporting apparatus according to one or more embodiments of the present disclosure.

FIG. 22 is a block diagram of a capability reporting apparatus according to one or more embodiments of the present disclosure.

FIG. 23 is a block diagram of a terminal according to one or more embodiments of the present disclosure.

FIG. 24 is a block diagram of a network device according to one or more embodiments of the present disclosure.

### DETAILED DESCRIPTION

Exemplary embodiments will be described in detail here, with examples shown in the drawings. When referring to the drawings, unless otherwise indicated, the same reference numerals in different drawings represent the same or similar elements. The embodiments described in the following exemplary embodiments do not represent all embodiments consistent with the present disclosure. On the contrary, they are only examples of devices and methods consistent with some aspects of the present disclosure as described in the appended claims.

It should be noted that all actions to obtain signals, information, or data in the present disclosure are carried out in accordance with the corresponding data protection regulations and policies of the country where they are located, and with authorization granted by the corresponding device owner.

In the present disclosure, terms such as “first”, “second”, etc. are used to distinguish similar objects and do not necessarily need to be understood as a specific order or sequence. In addition, unless otherwise indicated, in the description of the drawings, the same reference numerals in different drawings represent the same elements.

In the present disclosure, unless otherwise indicated, “multiple” refers to two or more, and other quantifiers are similar to this. The expressions such as “at least one of”, “one or more”, or similar expressions refer to any combination of these items, including any combination of single or plural items. For example, at least one can represent any quantity. For example, one or more of a, b, or c, can represent: a, b, c, a-b, a-c, b-c, or a-b-c, where a, b, and c can be single or multiple. The expression “and/or” describes an association relationship between related objects, indicating that there can be three types of relationships. For example, A and/or B can represent the existence of A alone, the existence of A and B at the same time, and the existence of B alone, where A and B can be singular or plural.

Although operations or steps are described in a specific order in the drawings in embodiments of the present disclosure, it should not be understood as requiring the execution of these operations or steps in the specific order or serial order shown, or requiring the execution of all shown operations or steps to achieve the desired results. In embodiments of the present disclosure, these operations or steps can be performed sequentially or in parallel, or only some of these operations or steps are performed.

The implementation environment of embodiments of the present disclosure will be introduced in the following first.

The technical solutions of embodiments of the present disclosure can be applied to various communication systems. The communication systems can include one or more of 4G (the 4th Generation) communication system, 5G (the 5th Generation) communication system, and other future wireless communication systems (such as 6G). The communication systems can also include one or more of Public Land Mobile Network (PLMN) networks, Device to Device (D2D) communication systems, Machine to Machine (M2M) communication systems, Internet of Things (IoT) communication systems, Vehicle to Everything (V2X) communication systems, or other communication systems.

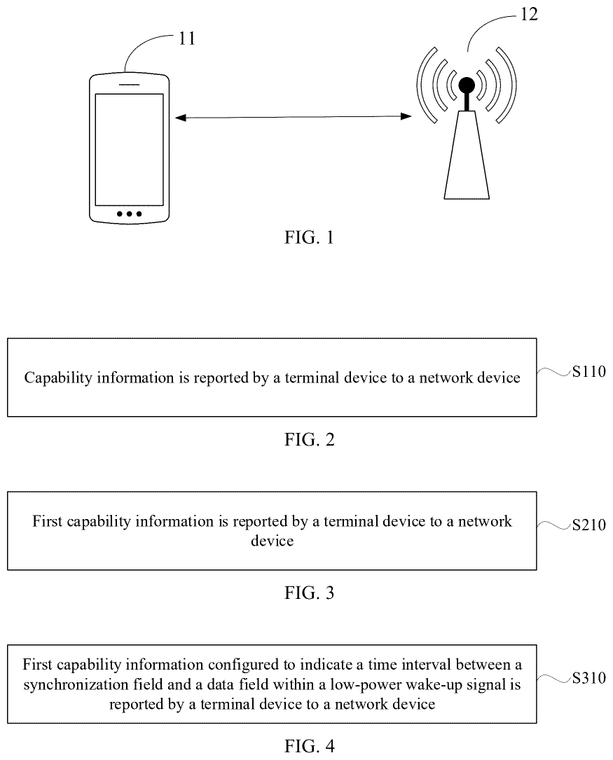

FIG. 1 is a schematic diagram of a communication system according to one or more embodiments of the present disclosure. As shown in FIG. 1, the communication system can include a terminal 11 and a network device 12. The communication system can be used to support 4G network access technology, such as Long Term Evolution (LTE) access technology, or 5G network access technology, such as New Radio Access Technology (New RAT), or other future wireless communication technology. It should be noted that in this communication system, the number of network devices 12 and terminals 11 can be one or more. The number of network devices 12 and terminals 11 in the communication system shown in FIG. 1 is only for an adaptive example, and the present disclosure does not limit this.

The network device 12 in FIG. 1 can be used to support the access of the terminal 11, for example, the network device 12 can be an evolved Node B (eNB or eNodeB) in LTE, a next generation Node B (gNB or gNodeB) in the 5G network, a radio access network (NG-RAN) device in the 5G network, a base station, a Broadband Network Gateway (BNG), and an aggregation switch in future evolved Public Land Mobile Network (PLMN), or a non-3rd Generation Partnership Project (3GPP) access device, etc.

In some embodiments, the network device 12 can include various forms of base stations, such as macro base stations, micro base stations (also known as small stations), relay stations, access points, 5G base stations or future base stations, satellites, transmission and reception points (TRP), transmission points (TP), mobile switching centers, device-to-device (D2D), machine-to-machine (M2M), Internet of Things (IoT), Vehicle to Everything (V2X), or other devices that achieve base-station functions in the communication. Embodiment of the present disclosure do not specifically limit this. For ease of description, in all embodiments of the present disclosure, the device that provides wireless communication functionality for the terminal 11 is collectively referred to as the network device 12 or a base station.

The terminal 11 in FIG. 1 can be an electronic device that provides voice or data connectivity. For example, the terminal 11 can also be referred to as user equipment (UE), subscriber units, mobile stations, stations, terminal devices, etc. For example, the terminal 11 can include a smartphone, a smart wearable device, a smart speaker, a smart tablet, a wireless modem, a wireless local loop (WLL) station, a personal digital assistant (PDA), customer premise equipment (CPE), etc. With the development of wireless communication technology, the terminal 11 in embodiments of the present disclosure can be used as device that can access a communication system, communicate with network devices in the communication system, communicate with other objects through the communication system, or perform direct communication between two or more devices. For example, the terminal 11 can be terminal devices and cars in intelligent transportations, household devices in intelligent homes, power meter reading instruments, voltage monitoring instruments, and environmental monitoring instruments in intelligent grids, video monitoring instruments in intelligent security networks, payment machines, etc. In embodiments of the present disclosure, the terminal 11 can communicate with the network device 12. Multiple terminals 11 can also communicate with each other. The terminal 11 can be statically fixed or mobile, and the present disclosure does not limit this.

In some embodiments, the terminal 11 in FIG. 1 may be a terminal that supports power saving function. The terminal can include a low-power (LP) wake-up receiver (WUR) and a main radio (MR), where the wake-up receiver can be referred to as LP-WUR. In some embodiments, in the absence of data transmission and reception, the main radio of the terminal 11 can be in varying degrees of sleep state.

In some embodiments, the sleep state of the terminal 11 can include one or more of ultra-deep sleep, deep sleep, light sleep, and micro sleep. The time required for the main radio of the terminal 11 to wake up from different sleep states varies. In addition, due to the different hardware or software capabilities of the terminal 11 itself, the time for different terminals 11 to be waked up from the same sleep state is also different.

It should be noted that the terminal 11 can be in a wake-up state after being waked up. The wake-up state of the terminal 11 can be considered as a different state relative to the sleep state, or as a special form of sleep state. The present disclosure does not limit this.

It should also be noted that the above main radio can include a main transceiver and/or a main receiver, where the number of the main transceiver can be one or more and the number of the main receiver can also be one or more.

The terminal 11 in FIG. 1 can support receiving of a low-power WUS.

In some embodiments, the terminal can receive the WUS using main radio (main transceiver and/or main receiver).

In some embodiments, the terminal can use a separate receiver to receive the WUS, and use a main transceiver to receive downlink signals and send uplink signals. The terminal can also use the main receiver to receive downlink signals. The main receiver and/or the main transceiver can be referred to as the main radio of the terminal. If the terminal receives a WUS which indicates to wake up the terminal, then the terminal will turn on the main transceiver for receiving and processing downlink/uplink information, or turn on the main receiver for receiving and processing downlink information. If no WUS is received, or if the WUS indicates not to wake up the terminal, the terminal will maintain the sleep state of the main transceiver and/or the main receiver. The WUS can be applied to any state of the terminal, such as a Radio Resource Control (RRC) connected state, an RRC idle state, or an RRC inactive state.

In some embodiments, the wake-up receiver can use an envelope detection method to determine the information carried by the received low-power wake-up signal. The detection can include amplitude detection or energy detection. That is, the terminal can determine, through the amplitude or energy of the low-power wake-up signal sent by the network device, the specific information carried by the low-power wake-up signal.

The method for modulating the low-power wake-up signal can include Multi-Carrier On-Off Keying (MC-OOK) modulation, Multi-Carrier Amplitude Shift Keying (MC-ASK) modulation, Multi-Carrier Frequency Shift Keying modulation, Phase Shift Keying modulation, and Amplitude modulation. In the Multi-Carrier On-Off Keying modulation, one time-domain symbol can carry up to two bits. That is, symbols with energy transmission can be the ‘ON’ symbol, which represents 1, and symbols without energy transmission can be the ‘OFF’ symbol, which represents 0. In some embodiments, in the Multi-Carrier Amplitude Shift Keying modulation, one time-domain symbol can carry multiple bits, and different bits can be obtained through different amplitudes.

The low-power wake-up signal can be modulated through one or more modulation modes such as the Multi-Carrier On-Off Keying modulation, the Multi-Carrier Amplitude Shift Keying modulation, etc. For example, for a low-power wake-up signal based on the Multi-Carrier On-Off Keying modulation, the wake-up receiver of the terminal needs to distinguish between high and low energy states to determine the bit information carried by each time-domain symbol. However, this modulation mode will occupy a significant amount of time-frequency resources. For a low-power wake-up signal based on the Multi-Carrier Amplitude Shift Keying modulation, the wake-up receiver of the terminal needs to distinguish at least four energy states, which will be greatly affected by noise. It can be seen that different modulation modes have different requirements for the terminal's capability. Therefore, how to ensure that the network device and the terminal have a common understanding of the modulation mode used for low-power wake-up signals is a problem that needs to be further clarified.

In some embodiments, there are two ways to synchronize the low-power wake-up signal. The first way is to achieve synchronization through a synchronization field of the low-power wake-up signal. That is, the terminal can first receive the synchronization field that maps a fixed sequence to complete preliminary synchronization and energy threshold determination, and then the terminal can receive a data field of the low-power wake-up signal. The second way is to achieve synchronization through a low-power synchronization signal. That is, the terminal can first receive a synchronization signal and then receive the low-power synchronization signal. In other words, the low-power synchronization signal is independent of the low-power wake-up signal.

From the above introduction, it is known that after receiving the synchronization field or the low-power synchronization signal, the terminal needs to complete synchronization, threshold determination, and other tasks. The time required for different terminals to complete the synchronization, the threshold determination, and other tasks varies. Therefore, how to maintain a sufficient interval between the synchronization field and the data field or between the synchronization signal and the low-power wake-up signal when the network device performs resource configuration is also a problem that needs to be further clarified.

FIG. 2 is a flowchart of a capability reporting method according to embodiments of the present disclosure. As shown in FIG. 2, the capability reporting method can be performed by a terminal, and includes the following steps.

In step S110, capability information is reported by a terminal to a network device.

In some embodiments, the terminal can report the capability information to the network device, where the capability information can be related to a low-power wake-up signal. In some embodiments, the capability information reported by the terminal to the network device can be property values supported by the terminal or recommended for network devices to refer to. In some embodiments, the capability information reported by the terminal to the network device can include the modulation mode used by the terminal to receive the low-power wake-up signal, the interval between the terminal receiving synchronization information and/or reference information and the terminal receiving the low-power wake-up signal, and the number of low-power wake-up signals received by the terminal. In some embodiments, the network device can include an access network device. The terminal can report the above capability information to the access network device. In some embodiments, the access network device can send the capability information of the terminal to a core network device through, for example, a registration request, so as to perform the network registration. In some embodiments, the network device can be a core network device, and the terminal can report the above capability information to the core network device. The core network device performs the registration and other operations based on the capability information of the terminal.

In some embodiments, the capability information reported by the terminal to the network device can be predefined by the protocol. In some embodiments, the capability information can be carried in signaling such as RRC, Uplink Control Information (UCI), Medium Access Control-Control Element (MAC CE), etc.

According to embodiments of the present disclosure, the terminal can report its capability information to the network device, where the capability information is related to the low-power wake-up signal, so that the network device can be allowed to configure the low-power wake-up signal more reasonably.

FIG. 3 is a flowchart of a capability reporting method according to embodiments of the present disclosure. As shown in FIG. 3, the capability reporting method can be performed by a terminal, and includes the following steps.

In step S210, first capability information is reported by a terminal to a network device.

In some embodiments of the present disclosure, the terminal can report the first capability information to the network device, where the first capability information can be predefined by the protocol. The first capability information can be configured to indicate a time interval and/or the number of time-domain symbols. The time interval can be the interval between synchronization information and wake-up information, or the interval between reference information and the wake-up information.

In some embodiments, the number of time-domain symbols can be the number of time-domain symbols occupied by the synchronous information, or the number of time-domain symbols occupied by the reference information, etc. By reporting the first capability information to the network device, different information transmissions can be separated by sufficient time.

It should be noted that, as long as there is no contradiction, embodiments of the present disclosure can be combined with other embodiments or implementations and their various optional solutions, which are used for the terminal to report its capability, and will not be repeated here.

It should be noted that the time interval in embodiments of the present disclosure can be a minimum time interval, and/or the number of time-domain symbols can be a minimum number of time-domain symbols.

It should be noted that the time interval in embodiments of the present disclosure can be a fixed value, which can be a fixed time value. In some embodiments, the fixed value can range from 0 μs to 500 μs, or from 0 ms to 10 ms. In some embodiments, the number of time-domain symbols in embodiments of the present disclosure can also be a fixed value, which can be a fixed number of symbols.

According to embodiments of the present disclosure, the terminal can report the first capability information to the network device, where the first capability information can be configured to indicate the time interval or the number of time-domain symbols, etc., so that the terminal can have sufficient time to complete the synchronization, the threshold calculation, and other tasks.

FIG. 4 is a flowchart of a capability reporting method according to embodiments of the present disclosure. As shown in FIG. 4, the capability reporting method can be performed by a terminal, and includes the following steps.

In step S310, first capability information configured to indicate a time interval between a synchronization field and a data field within a low-power wake-up signal is reported by a terminal to a network device.

In some embodiments of the present disclosure, the low-power wake-up signal can include a synchronization field and a data field, and the terminal can report to the network device the first capability information configured to indicate a time interval between the synchronization field and the data field within the low-power wake-up signal.

In some embodiments, the time interval between the synchronization field of the low-power wake-up signal and the data field of the low-power wake-up signal can include at least one of the following: the number of symbols between a first/last time-domain symbol in the synchronization field and a first/last time-domain symbol in the data field, or the number of time slots between a time slot where a first/last time-domain symbol in the synchronization field is located and a time slot where a first/last time-domain symbol in the data field is located.

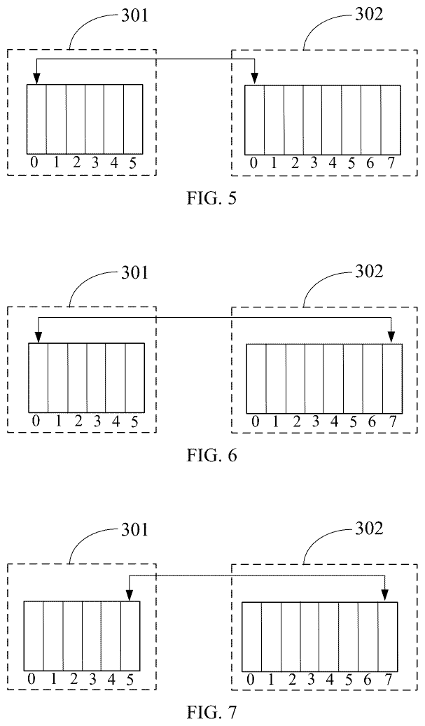

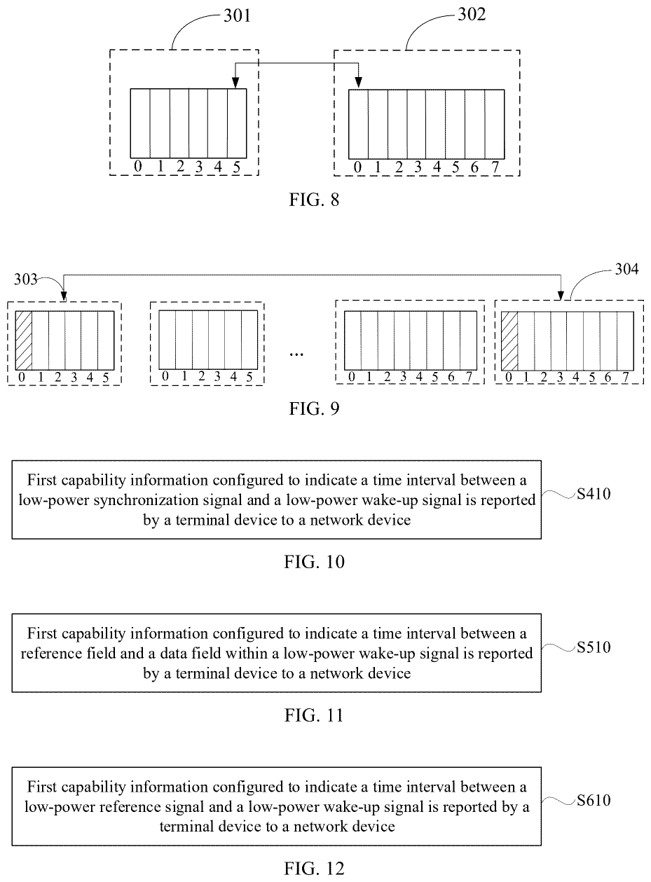

In some embodiments, the number of symbols between the first/last time-domain symbol in the synchronization field and the first/last time-domain symbol in the data field can include at least one of the following: the number of symbols between the first time-domain symbol in the synchronization field and the first time-domain symbol in the data field, which is shown in detail in FIG. 5, where 301 represents the synchronization field and 302 represents the data field; the number of symbols between the first time-domain symbol in the synchronization field and the last time-domain symbol in the data field, which is shown in detail in FIG. 6; the number of symbols between the last time-domain symbol in the synchronization field and the last time-domain symbol in the data field, which is shown in detail in FIG. 7; or the number of symbols between the last time-domain symbol in the synchronization field and the first time-domain symbol in the data field, which is shown in detail in FIG. 8.

In some embodiments, the number of symbols between the first/last time-domain symbol in the synchronization field and the first/last time-domain symbol in the data field can range from 0-14.

In some embodiments, the number of time slots between the time slot where the first/last time-domain symbol in the synchronization field is located and the time slot where the first/last time-domain symbol in the data field is located can include at least one of the following: the number of time slots between the time slot where the first time-domain symbol in the synchronization field is located and the time slot where the first time-domain symbol in the data field is located, which is shown in FIG. 9, where 303 represents the time slot where the first time-domain symbol in the synchronization field is located and 304 represents the time slot where the first time-domain symbol in the data field is located; the number of time slots between the time slot where the first time-domain symbol in the synchronization field is located and the time slot where the last time-domain symbol in the data field is located; the number of time slots between the time slot where the last time-domain symbol in the synchronization field is located and the time slot where the first time-domain symbol in the data field is located; or the number of time slots between the time slot where the last time-domain symbol in the synchronization field is located and the time slot where the last time-domain symbol in the data field is located.

In some embodiments, the number of time slots between the time slot where the first/last time-domain symbol in the synchronization field is located and the time slot where the first/last time-domain symbol in the data field is located can range from 0 to 10.

It should be noted that, as long as there is no contradiction, embodiments of the present disclosure can be combined with other embodiments or implementations and their various optional solutions, which are used for the terminal to report its capability, and will not be repeated here.

It should be noted that the time interval in embodiments of the present disclosure can be a minimum time interval, and/or the number of time-domain symbols can be a minimum number of time-domain symbols.

It should be noted that the time interval in embodiments of the present disclosure can be a fixed value, which can be a fixed time value. In some embodiments, the fixed value can range from 0 μs to 500 μs, or from 0 ms to 10 ms. In some embodiments, the number of time-domain symbols in embodiments of the present disclosure can also be a fixed value, which can be a fixed number of symbols.

According to embodiments of the present disclosure, the terminal can report the first capability information to the network device, where the first capability information can be configured to indicate the time interval between the synchronization field and the data field within the low-power wake-up signal, so that the terminal can have sufficient time to complete the synchronization, the threshold calculation, and other tasks.

FIG. 10 is a flowchart of a capability reporting method according to embodiments of the present disclosure. As shown in FIG. 10, the capability reporting method can be performed by a terminal, and includes the following steps.

In step S410, first capability information configured to indicate a time interval between a low-power synchronization signal and a low-power wake-up signal is reported by a terminal to a network device.

In some embodiments of the present disclosure, before receiving the low-power wake-up signal, the terminal can first receive the low-power synchronization signal. That is, the low-power synchronization signal is sent independently of the low-power wake-up signal, and the low-power synchronization signal can be sent to the terminal before the low-power wake-up signal. Therefore, the terminal can report the first capability information configured to indicate a time interval between the low-power synchronization signal and the low-power wake-up signal to the network device.

In some embodiments, the time interval between the low-power synchronization signal and the low-power wake-up signal includes at least one of the following: the number of symbols between a first/last time-domain symbol of the low-power synchronization signal and a first/last time-domain symbol of the low-power wake-up signal, or the number of time slots between a time slot where a first/last time-domain symbol of the low-power synchronization signal is located and a time slot where a first/last time-domain symbol of the low-power wake-up signal is located.

In some embodiments, the number of symbols between the first/last time-domain symbol of the low-power synchronization signal and the first/last time-domain symbol of the low-power wake-up signal can include at least one of the following: the number of symbols between the first time-domain symbol of the low-power synchronization signal and the first time-domain symbol of the low-power wake-up signal, which is shown in FIG. 5, where 301 represents the low-power synchronization signal and 302 represents the low-power wake-up signal; the number of symbols between the first time-domain symbol of the low-power synchronization signal and the last time-domain symbol of the low-power wake-up signal, which is shown in FIG. 6; the number of symbols between the last time-domain symbol of the low-power synchronization signal and the last time-domain symbol of the low-power wake-up signal, which is shown in FIG. 7; or the number of symbols between the last time-domain symbol of the low-power synchronization signal and the first time-domain symbol of the low-power wake-up signal, which is shown in FIG. 8.

In some embodiments, the number of symbols between the first/last time-domain symbol of the low-power synchronization signal and the first/last time-domain symbol of the low-power wake-up signal can range from 0-14.

In some embodiments, the number of time slots between the time slot where the first/last time-domain symbol of the low-power synchronization signal is located and the time slot where the first/last time-domain symbol of the low-power wake-up signal is located can include at least one of the following: the number of time slots between the time slot where the first time-domain symbol of the low-power synchronization signal is located and the time slot where the first time-domain symbol of the low-power wake-up signal is located, which is shown in FIG. 9, where 303 represents the time slot where the first time-domain symbol of the low-power synchronization signal is located and 304 represents the time slot where the first time-domain symbol of the low-power wake-up signal is located; the number of time slots between the time slot where the first time-domain symbol of the low-power synchronization signal is located and the time slot where the last time-domain symbol of the low-power wake-up signal is located; the number of time slots between the time slot where the last time-domain symbol of the low-power synchronization signal is located and the time slot where the first time-domain symbol of the low-power wake-up signal is located; or the number of time slots between the time slot where the last time-domain symbol of the low-power synchronization signal is located and the time slot where the last time-domain symbol of the low-power wake-up signal is located.

In some embodiments, the number of time slots between the time slot where the first/last time-domain symbol of the low-power synchronization signal is located and the time slot where the first/last time-domain symbol of the low-power wake-up signal is located can range from 0 to 10.

It should be noted that, as long as there is no contradiction, embodiments of the present disclosure can be combined with other embodiments or implementations and their various optional solutions, which are used for the terminal to report its capability, and will not be repeated here.

It should be noted that the time interval in embodiments of the present disclosure can be a minimum time interval, and/or the number of time-domain symbols can be a minimum number of time-domain symbols.

It should be noted that the time interval in embodiments of the present disclosure can be a fixed value, which can be a fixed time value. In some embodiments, the fixed value can range from 0 μs to 500 μs, or from 0 ms to 10 ms. In some embodiments, the number of time-domain symbols in embodiments of the present disclosure can also be a fixed value, which can be a fixed number of symbols.

According to embodiments of the present disclosure, the terminal can report the first capability information to the network device, where the first capability information can be configured to indicate the time interval between the low-power synchronization signal and the low-power wake-up signal, so that the terminal can have sufficient time to complete the synchronization, the threshold calculation, and other tasks.

FIG. 11 is a flowchart of a capability reporting method according to embodiments of the present disclosure. As shown in FIG. 11, the capability reporting method can be performed by a terminal, and includes the following steps.

In step S510, first capability information configured to indicate a time interval between a reference field and a data field within a low-power wake-up signal is reported by a terminal to a network device.

In some embodiments of the present disclosure, the low-power wake-up signal can include a reference field and a data field, and the terminal can report to the network device the first capability information configured to indicate a time interval between the reference field and the data field within the low-power wake-up signal.

In some embodiments, the reference field of the low-power wake-up signals can be used to determine the maximum energy, the average energy, or the sending power. In some embodiments, the terminal can determine the maximum energy, the average energy, or the sending power based on sending energy/power of the network device and receiving energy/power of the terminal in the reference field.

In some embodiments, the time interval between the reference field of the low-power wake-up signal and the data field of the low-power wake-up signal can include at least one of the following: the number of symbols between a first/last time-domain symbol in the reference field and a first/last time-domain symbol in the data field, or the number of time slots between a time slot where a first/last time-domain symbol in the reference field is located and a time slot where a first/last time-domain symbol in the data field is located.

In some embodiments, the number of symbols between the first/last time-domain symbol in the reference field and the first/last time-domain symbol in the data field can include at least one of the following: the number of symbols between the first time-domain symbol in the reference field and the first time-domain symbol in the data field, which is shown in FIG. 5, where 301 represents the reference field and 302 represents the data field; the number of symbols between the first time-domain symbol in the reference field and the last time-domain symbol in the data field, which is shown in FIG. 6; the number of symbols between the last time-domain symbol in the reference field and the last time-domain symbol in the data field, which is shown in FIG. 7; or the number of symbols between the last time-domain symbol in the reference field and the first time-domain symbol in the data field, which is shown in FIG. 8.

In some embodiments, the number of time slots between the time slot where the first/last time-domain symbol in the reference field is located and the time slot where the first/last time-domain symbol in the data field is located can include at least one of the following: the number of time slots between the time slot where the first time-domain symbol in the reference field is located and the time slot where the first time-domain symbol in the data field is located, which is shown in FIG. 9, where 303 represents the time slot where the first time-domain symbol in the reference field is located and 304 represents the time slot where the first time-domain symbol in the data field is located; the number of time slots between the time slot where the first time-domain symbol in the reference field is located and the time slot where the last time-domain symbol in the data field is located; the number of time slots between the time slot where the last time-domain symbol in the reference field is located and the time slot where the first time-domain symbol in the data field is located; or the number of time slots between the time slot where the last time-domain symbol in the reference field is located and the time slot where the last time-domain symbol in the data field is located.

It should be noted that, as long as there is no contradiction, embodiments of the present disclosure can be combined with other embodiments or implementations and their various optional solutions, which are used for the terminal to report its capability, and will not be repeated here.

It should be noted that the time interval in embodiments of the present disclosure can be a minimum time interval, and/or the number of time-domain symbols can be a minimum number of time-domain symbols.

It should be noted that the time interval in embodiments of the present disclosure can be a fixed value, which can be a fixed time value. In some embodiments, the fixed value can range from 0 μs to 500 μs, or from 0 ms to 10 ms. In some embodiments, the number of time-domain symbols in embodiments of the present disclosure can also be a fixed value, which can be a fixed number of symbols.

According to embodiments of the present disclosure, the terminal can report the first capability information to the network device, where the first capability information can be configured to indicate the time interval between the reference field and the data field within the low-power wake-up signal, so that the terminal can have sufficient time to complete the synchronization, the threshold calculation, and other tasks.

FIG. 12 is a flowchart of a capability reporting method according to embodiments of the present disclosure. As shown in FIG. 12, the capability reporting method can be performed by a terminal, and includes the following steps.

In step S610, first capability information configured to indicate a time interval between a low-power reference signal and a low-power wake-up signal is reported by a terminal to a network device.

In some embodiments of the present disclosure, before receiving the low-power wake-up signal, the terminal can first receive the low-power reference signal. That is, the low-power reference signal can be sent independently of the low-power wake-up signal. Therefore, the terminal can report the first capability information configured to indicate a time interval between the low-power reference signal and the low-power wake-up signal to the network device.

In some embodiments, the low-power reference signal can be used to determine the maximum energy, the average energy, or the sending power. In some embodiments, the terminal can determine the maximum energy, the average energy, or the sending power based on sending energy/power of the network device and receiving energy/power of the terminal in the low-power reference signal. The low-power reference signal can be sent to the terminal before the low-power wake-up signal.

In some embodiments, the time interval between the low-power reference signal and the low-power wake-up signal includes at least one of the following: the number of symbols between a first/last time-domain symbol of the low-power reference signal and a first/last time-domain symbol of the low-power wake-up signal, or the number of time slots between a time slot where a first/last time-domain symbol of the low-power reference signal is located and a time slot where a first/last time-domain symbol of the low-power wake-up signal is located.

In some embodiments, the number of symbols between the first/last time-domain symbol of the low-power reference signal and the first/last time-domain symbol of the low-power wake-up signal can include at least one of the following: the number of symbols between the first time-domain symbol of the low-power reference signal and the first time-domain symbol of the low-power wake-up signal, which is shown in FIG. 5, where 301 represents the low-power reference signal and 302 represents the low-power wake-up signal; the number of symbols between the first time-domain symbol of the low-power reference signal and the last time-domain symbol of the low-power wake-up signal, which is shown in FIG. 6; the number of symbols between the last time-domain symbol of the low-power reference signal and the last time-domain symbol of the low-power wake-up signal, which is shown in FIG. 7; or the number of symbols between the last time-domain symbol of the low-power reference signal and the first time-domain symbol of the low-power wake-up signal, which is shown in FIG. 8.

In some embodiments, the number of time slots between the time slot where the first/last time-domain symbol of the low-power reference signal is located and the time slot where the first/last time-domain symbol of the low-power wake-up signal is located can include at least one of the following: the number of time slots between the time slot where the first time-domain symbol of the low-power reference signal is located and the time slot where the first time-domain symbol of the low-power wake-up signal is located, which is shown in FIG. 9, where 303 represents the time slot where the first time-domain symbol of the low-power reference signal is located and 304 represents the time slot where the first time-domain symbol of the low-power wake-up signal is located; the number of time slots between the time slot where the first time-domain symbol of the low-power reference signal is located and the time slot where the last time-domain symbol of the low-power wake-up signal is located; the number of time slots between the time slot where the last time-domain symbol of the low-power reference signal is located and the time slot where the first time-domain symbol of the low-power wake-up signal is located; or the number of time slots between the time slot where the last time-domain symbol of the low-power reference signal is located and the time slot where the last time-domain symbol of the low-power wake-up signal is located.

It should be noted that, as long as there is no contradiction, embodiments of the present disclosure can be combined with other embodiments or implementations and their various optional solutions, which are used for the terminal to report its capability, and will not be repeated here.

It should be noted that the time interval in embodiments of the present disclosure can be a minimum time interval, and/or the number of time-domain symbols can be a minimum number of time-domain symbols.

It should be noted that the time interval in embodiments of the present disclosure can be a fixed value, which can be a fixed time value. In some embodiments, the fixed value can range from 0 μs to 500 μs, or from 0 ms to 10 ms. In some embodiments, the number of time-domain symbols in embodiments of the present disclosure can also be a fixed value, which can be a fixed number of symbols.

According to embodiments of the present disclosure, the terminal can report the first capability information to the network device, where the first capability information can be configured to indicate the time interval between the low-power reference signal and the low-power wake-up signal, so that the terminal can have sufficient time to complete the synchronization, the threshold calculation, and other tasks.

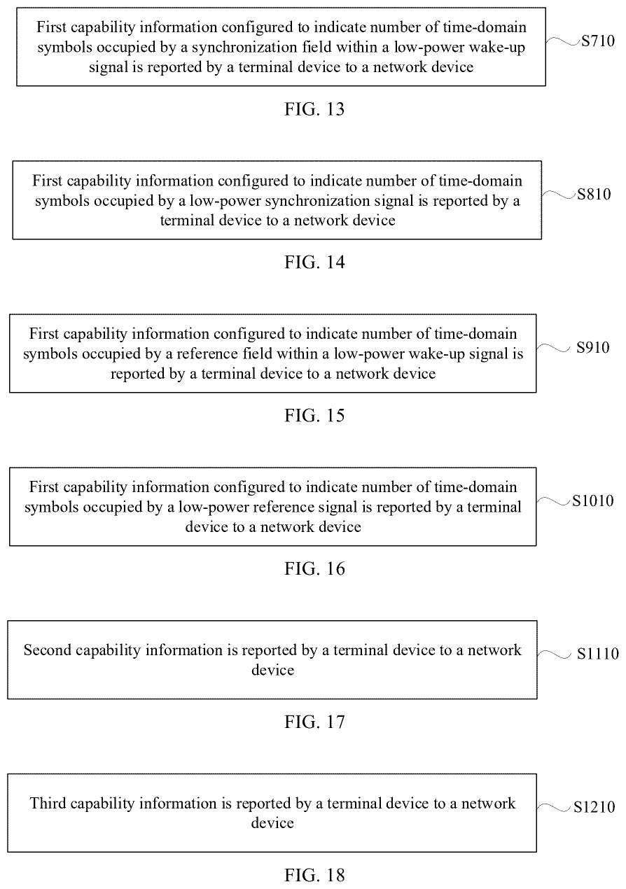

FIG. 13 is a flowchart of a capability reporting method according to embodiments of the present disclosure. As shown in FIG. 13, the capability reporting method can be performed by a terminal, and includes the following steps.

In step S710, first capability information configured to indicate the number of time-domain symbols occupied by a synchronization field within a low-power wake-up signal is reported by a terminal to a network device.

In some embodiments, the low-power wake-up signal can include a synchronization field and a data field, and the terminal can report to the network device the first capability information configured to indicate the number of time-domain symbols occupied by the synchronization field within the low-power wake-up signal. That is, the first capability information can include the number of time-domain symbols occupied by the synchronization field within the low-power wake-up signal. In this way, the terminal is allowed to have sufficient time to complete the synchronization while saving resources.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the first capability information to the network device, where the first capability information can be configured to indicate the number of time-domain symbols occupied by the synchronization field within the low-power wake-up signal, so that the terminal can have sufficient time to complete the synchronization, the threshold calculation, and other tasks.

FIG. 14 is a flowchart of a capability reporting method according to embodiments of the present disclosure. As shown in FIG. 14, the capability reporting method can be performed by a terminal, and includes the following steps.

In step S810, first capability information configured to indicate the number of time-domain symbols occupied by a low-power synchronization signal is reported by a terminal to a network device.

In some embodiments, the low-power synchronization signal can be sent independently of the low-power wake-up signal, and the terminal can report the first capability information configured to indicate the number of time-domain symbols occupied by the low-power synchronization signal to the network device. That is, the first capability information can include the number of time-domain symbols occupied by the low-power synchronization signal. In this way, the terminal is allowed to have sufficient time to complete the synchronization while saving resources.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the first capability information to the network device, where the first capability information can be configured to indicate the number of time-domain symbols occupied by the low-power synchronization signal, so that the terminal can have sufficient time to complete the synchronization, the threshold calculation, and other tasks.

FIG. 15 is a flowchart of a capability reporting method according to embodiments of the present disclosure. As shown in FIG. 15, the capability reporting method can be performed by a terminal, and includes the following steps.

In step S910, first capability information configured to indicate the number of time-domain symbols occupied by a reference field within a low-power wake-up signal is reported by a terminal to a network device.

In some embodiments, the low-power wake-up signal can include a reference field and a data field, and the terminal can report to the network device the first capability information configured to indicate the number of time-domain symbols occupied by the reference field within the low-power wake-up signal. That is, the first capability information can include the number of time-domain symbols occupied by the reference field within the low-power wake-up signal. In this way, the terminal is allowed to have sufficient time to complete the energy threshold calculation while saving resources.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the first capability information to the network device, where the first capability information can be configured to indicate the number of time-domain symbols occupied by the reference field within the low-power wake-up signal, so that the terminal can have sufficient time to complete the synchronization, the threshold calculation, and other tasks.

FIG. 16 is a flowchart of a capability reporting method according to embodiments of the present disclosure. As shown in FIG. 16, the capability reporting method can be performed by a terminal, and includes the following steps.

In step S110, first capability information configured to indicate the number of time-domain symbols occupied by a low-power reference signal is reported by a terminal to a network device.

In some embodiments, the low-power reference signal can be sent independently of the low-power wake-up signal, and the terminal can report the first capability information configured to indicate the number of time-domain symbols occupied by the low-power reference signal to the network device. That is, the first capability information can include the number of time-domain symbols occupied by the low-power reference signal. In this way, the terminal is allowed to have sufficient time to complete the energy threshold calculation while saving resources.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the first capability information to the network device, where the first capability information can be configured to indicate the number of time-domain symbols occupied by the low-power reference signal, so that the terminal can have sufficient time to complete the synchronization, the threshold calculation, and other tasks.

FIG. 17 is a flowchart of a capability reporting method according to embodiments of the present disclosure. As shown in FIG. 17, the capability reporting method can be performed by a terminal, and includes the following steps.

In step S1110, second capability information is reported by a terminal to a network device.

In some embodiments of the present disclosure, the terminal can report the second capability information to the network device, where the second capability information can be predefined by the protocol. The second capability information can be configured to indicate a modulation mode of a low-power wake-up signal supported by the terminal.

In some embodiments, the modulation mode of the low-power wake-up signal supported by the terminal can include at least one of Multi-Carrier On-Off Keying modulation, Multi-Carrier Amplitude Shift Keying modulation, Multi-Carrier Frequency Shift Keying modulation, Phase Shift Keying modulation, or Quadrature Amplitude modulation.

In some embodiments, the modulation mode of the low-power wake-up signal supported by the terminal can include the Multi-Carrier On-Off Keying (MC-OOK) modulation. Based on the protocol, the terminal can support the Multi-Carrier On-Off Keying (MC-OOK) modulation, which means that the terminal can receive and demodulate the low-power wake-up signal processed through the Multi-Carrier On-Off Keying (MC-OOK) modulation. In some embodiments, the modulation modes of the low-power wake-up signal, the low-power synchronization signal, and the low-power reference signal can be the same. In other words, the terminal can not only receive and demodulate the low-power wake-up signal processed through the Multi-Carrier On-Off Keying (MC-OOK) modulation, but also receive and demodulate the low-power synchronization signal and/or reference signal processed through the Multi-Carrier On-Off Keying (MC-OOK) modulation.

In some embodiments, the modulation mode of the low-power wake-up signal supported by the terminal can include the Multi-Carrier Amplitude Shift Keying (MC-ASK) modulation. Based on the protocol, the terminal can support the Multi-Carrier Amplitude Shift Keying (MC-ASK) modulation, which means that the terminal can receive and demodulate the low-power wake-up signal processed through the Multi-Carrier Amplitude Shift Keying (MC-ASK) modulation. In some embodiments, the modulation modes of the low-power wake-up signal, the low-power synchronization signal, and the low-power reference signal can be the same. In other words, the terminal can not only receive and demodulate the low-power wake-up signal processed through the Multi-Carrier Amplitude Shift Keying (MC-ASK) modulation, but also receive and demodulate the low-power synchronization signal and/or reference signal processed through the Multi-Carrier Amplitude Shift Keying (MC-ASK) modulation.

In some embodiments, the modulation mode of the low-power wake-up signal supported by the terminal can include the Multi-Carrier Frequency Shift Keying (MC-FSK) modulation. Based on the protocol, the terminal can support the Multi-Carrier Frequency Shift Keying (MC-FSK) modulation, which means that the terminal can receive and demodulate the low-power wake-up signal processed through the Multi-Carrier Frequency Shift Keying (MC-FSK) modulation. In some embodiments, the modulation modes of the low-power wake-up signal, the low-power synchronization signal, and the low-power reference signal can be the same. In other words, the terminal can not only receive and demodulate the low-power wake-up signal processed through the Multi-Carrier Frequency Shift Keying (MC-FSK) modulation, but also receive and demodulate the low-power synchronization signal and/or reference signal processed through the Multi-Carrier Frequency Shift Keying (MC-FSK) modulation.

In some embodiments, the modulation mode of the low-power wake-up signal supported by the terminal can include the Phase Shift Keying (PSK) modulation. Based on the protocol, the terminal can support the Phase Shift Keying (PSK) modulation, which means that the terminal can receive and demodulate the low-power wake-up signal processed through the Phase Shift Keying (PSK) modulation. In some embodiments, the modulation modes of the low-power wake-up signal, the low-power synchronization signal, and the low-power reference signal can be the same. In other words, the terminal can not only receive and demodulate the low-power wake-up signal processed through the Phase Shift Keying (PSK) modulation, but also receive and demodulate the low-power synchronization signal and/or reference signal processed through the Phase Shift Keying (PSK) modulation.

In some embodiments, the modulation mode of the low-power wake-up signal supported by the terminal can include the Quadrature Amplitude modulation (QAM). Based on the protocol, the terminal can support the Quadrature Amplitude modulation (QAM), which means that the terminal can receive and demodulate the low-power wake-up signal processed through the Quadrature Amplitude modulation (QAM). In some embodiments, the modulation modes of the low-power wake-up signal, the low-power synchronization signal, and the low-power reference signal can be the same. In other words, the terminal can not only receive and demodulate the low-power wake-up signal processed through the Quadrature Amplitude modulation (QAM), but also receive and demodulate the low-power synchronization signal and/or reference signal processed through the Quadrature Amplitude modulation (QAM).

The terminal can support any of the above modulation modes only, or can support multiple modulation modes simultaneously. For example, the modulation modes of the low-power wake-up signal supported by the terminal can include the Multi-Carrier On-Off Keying (MC-OOK) modulation and the Multi-Carrier Amplitude Shift Keying (MC-ASK) modulation. Based on the protocol, the terminal can support the Multi-Carrier On-Off Keying (MC-OOK) modulation and the Multi-Carrier Amplitude Shift Keying (MC-ASK) modulation, which means that the terminal can receive and demodulate the low-power wake-up signal processed through the Multi-Carrier On-Off Keying (MC-OOK) modulation and the Multi-Carrier Amplitude Shift Keying (MC-ASK) modulation. In some embodiments, the modulation modes of the low-power wake-up signal, the low-power synchronization signal, and the low-power reference signal can be the same. In other words, the terminal can not only receive and demodulate the low-power wake-up signal processed through the Multi-Carrier On-Off Keying (MC-OOK) modulation and the Multi-Carrier Amplitude Shift Keying (MC-ASK) modulation, but also receive and demodulate the low-power synchronization signal and/or reference signal processed through the Multi-Carrier On-Off Keying (MC-OOK) modulation and the Multi-Carrier Amplitude Shift Keying (MC-ASK) modulation.

The above introduction of modulation modes is only an example. The specific modulation modes supported by the terminal will not be elaborated here, and can be selected according to actual situations.

In some embodiments of the present disclosure, the Multi-Carrier Amplitude Shift Keying (MC-ASK) modulation can include multiple sub MC-ASK modulation modes. In some embodiments, when at least one symbol processed through MC-ASK corresponds to two bits, the MC-ASK can be defined as the first MC-ASK, and when at least one symbol processed through MC-ASK corresponds to three bits, the MC-ASK can be defined as the second MC-ASK.

In some embodiments, the terminal can also support all modulation modes specified in the protocol. That is, the terminal can receive and demodulate at least one of the low-power wake-up signal, the low-power synchronization signal, and the low-power reference signal processed through all modulation modes specified in the protocol.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the second capability information to the network device, where the second capability information can be configured to indicate the modulation mode of the low-power wake-up signal supported by the terminal, thereby saving resources and improving the transmission reliability.

FIG. 18 is a flowchart of a capability reporting method according to embodiments of the present disclosure. As shown in FIG. 18, the capability reporting method can be performed by a terminal, and includes the following steps.

In step S1210, third capability information is reported by a terminal to a network device.

In some embodiments, the terminal can report the third capability information to the network device, where the third capability information can be configured to indicate at least one of: the number of low-power wake-up signals required to be received by the terminal to wake up the main radio, the number of low-power synchronization signals required to be received by the terminal to wake up the main radio, the number of low-power reference signals required to be received by the terminal to wake up the main radio, the number of bits carried by one time-domain symbol of the low-power wake-up signal required to be received by the terminal to wake up the main radio, or the number of bits carried by two time-domain symbols of the low-power wake-up signal required to be received by the terminal to wake up the main radio.

In some embodiments, when the terminal has a stronger capability, fewer low-power wake-up signals, low-power synchronization signals, low-power reference signals the number of bits carried by one time-domain symbol of the low-power wake-up signal, and the number of bits carried by two time-domain symbols of the low-power wake-up signal, are required to wake up the main radio. In this case, a relatively strong capability can be reported. In some embodiments, when the terminal has a weaker capability, the more low-power wake-up signals, low-power synchronization signals, low-power reference signals, the number of bits carried by one time-domain symbol of the low-power wake-up signal, and the number of bits carried by two time-domain symbols of the low-power wake-up signal, required to be received to wake up the main radio will be needed. In this case, a relatively weaker capability can be reported.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can report the third capability information to the network device, where the third capability information can be configured to indicate the number of low-power wake-up signals, the number of low-power synchronization signals, the number of low-power reference signals, the number of bits carried by one time-domain symbol of the low-power wake-up signal, and the number of bits carried by two time-domain symbols of the low-power wake-up signal required to be received by the terminal to wake up the main radio, thereby increasing the probability of the terminal to be waked up.

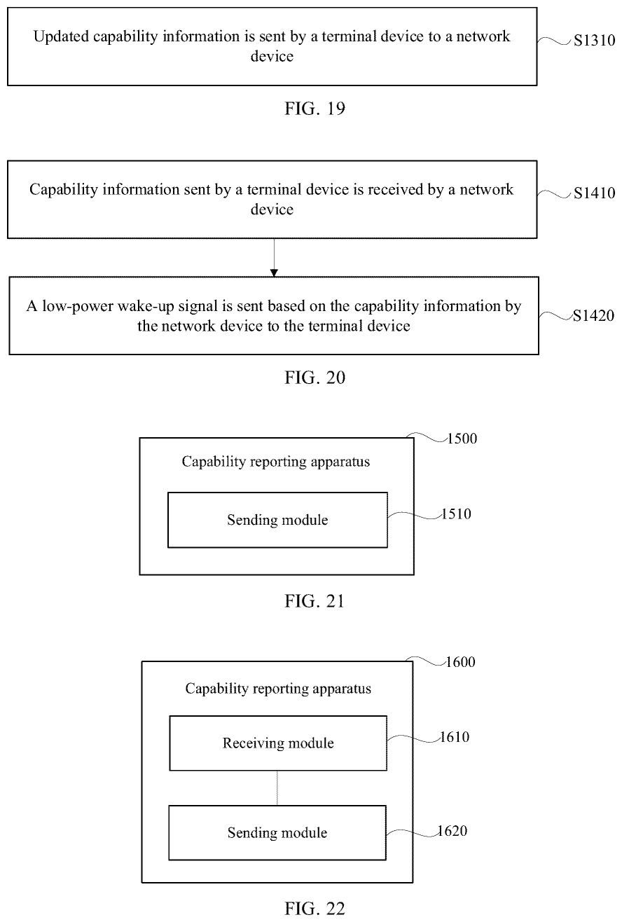

FIG. 19 is a flowchart of a capability reporting method according to embodiments of the present disclosure. As shown in FIG. 19, the capability reporting method can be performed by a terminal, and includes the following steps.

In step S1310, updated capability information is sent by a terminal to a network device.

In some embodiments, after reporting the capability information to the network device, if the terminal detects a change in a certain capability, it can update the corresponding capability information. For example, the modulation mode of the low-power wake-up signal supported by the terminal at a first moment is the Multi-Carrier On-Off Keying (MC-OOK) modulation, and at a second moment, the modulation mode of the low-power wake-up signal supported by the terminal becomes the Multi-Carrier On-Off Keying (MC-OOK) modulation and the Multi-Carrier Amplitude Shift Keying (MC-ASK) modulation.

In some embodiments, when it is determined that the capability information of the terminal has changed, the terminal can send the changed capability information to the network device. For example, if the Multi-Carrier Amplitude Shift Keying (MC-ASK) modulation is added to the modulation mode of the low-power wake-up signal supported by the terminal, the terminal can report only the Multi-Carrier Amplitude Shift Keying (MC-ASK) modulation to the network device.

In some embodiments, the terminal can also report the newly added capability information along with the original capability information to the network device. For example, if the Multi-Carrier Amplitude Shift Keying (MC-ASK) modulation is added to the modulation mode of the low-power wake-up signal supported by the terminal, the terminal can report the Multi-Carrier On-Off Keying (MC-OOK) modulation and the Multi-Carrier Amplitude Shift Keying (MC-ASK) modulation to the network device. How to send the updated capability information to the network device is not explicitly restricted here, and can be selected according to actual situations.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the terminal can update the capability information and send the updated capability information to the network device after determining that its capability has changed, thereby ensuring the real-time performance of the capability information.

FIG. 20 is a flowchart of a capability reporting method according to embodiments of the present disclosure. As shown in FIG. 20, the capability reporting method can be performed by a network device, and includes the following steps.

In step S1410, capability information sent by a terminal is received by a network device.

In some embodiments of the present disclosure, the network device can receive the capability information sent by the terminal, where the capability information is related to a low-power wake-up signal.

In some embodiments, the capability information can include first capability information, and the first capability information is configured to indicate at least one of following information: a time interval between a synchronization field and a data field within the low-power wake-up signal, a time interval between a low-power synchronization signal and the low-power wake-up signal, a time interval between a reference field and the data field within the low-power wake-up signal, a time interval between a low-power reference signal and the low-power wake-up signal, the number of time-domain symbols occupied by the synchronization field of the low-power wake-up signal, the number of time-domain symbols occupied by the low-power synchronization signal, the number of time-domain symbols occupied by the reference field of the low-power wake-up signal, or the number of time-domain symbols occupied by the low-power reference signal.

In some embodiments, the time interval between the synchronization field and the data field within the low-power wake-up signal includes at least one of the following: the number of symbols between a first/last time-domain symbol in the synchronization field and a first/last time-domain symbol in the data field, or the number of time slots between a time slot where the first/last time-domain symbol in the synchronization field is located and a time slot where the first/last time-domain symbol in the data field is located.

In some embodiments, the time interval between the low-power synchronization signal and the low-power wake-up signal includes at least one of the following: the number of symbols between a first/last time-domain symbol of the low-power synchronization signal and a first/last time-domain symbol of the low-power wake-up signal, or the number of time slots between a time slot where the first/last time-domain symbol of the low-power synchronization signal is located and a time slot where the first/last time-domain symbol of the low-power wake-up signal is located.

In some embodiments, the time interval between the reference field and the data field within the low-power wake-up signal includes at least one of the following: the number of symbols between a first/last time-domain symbol in the reference field and a first/last time-domain symbol in the data field, or the number of time slots between a time slot where the first/last time-domain symbol in the reference field is located and a time slot where the first/last time-domain symbol in the data field is located.

In some embodiments, the time interval between the low-power reference signal and the low-power wake-up signal includes at least one of the following: the number of symbols between a first/last time-domain symbol of the low-power reference signal and a first/last time-domain symbol of the low-power wake-up signal, or the number of time slots between a time slot where the first/last time-domain symbol of the low-power reference signal is located and a time slot where the first/last time-domain symbol of the low-power wake-up signal is located.

In some embodiments, the time interval includes a minimum time interval, and/or the number of time-domain symbols includes a minimum number of time-domain symbols.

In some embodiments, the time interval is a fixed value, and/or the number of time-domain symbols is a fixed value.

In some embodiments, the capability information can further include second capability information, and the second capability information is configured to indicate a modulation mode of the low-power wake-up signal supported by the terminal.

In some embodiments, the modulation mode of the low-power wake-up signal supported by the terminal can include at least one of the following: Multi-Carrier On-Off Keying modulation, Multi-Carrier Amplitude Shift Keying modulation, Multi-Carrier Frequency Shift Keying modulation, Phase Shift Keying modulation, or Quadrature Amplitude modulation.

In some embodiments, the capability information can further include third capability information, and the third capability information is configured to indicate at least one of following information: the number of low-power wake-up signals required to be received by the terminal to wake up a main radio, the number of low-power synchronization signals required to be received by the terminal to wake up the main radio, the number of low-power reference signals required to be received by the terminal to wake up the main radio, the number of bits carried by one time-domain symbol of the low-power wake-up signal required to be received by the terminal to wake up the main radio, or the number of bits carried by two time-domain symbols of the low-power wake-up signal required to be received by the terminal to wake up the main radio.

In some embodiments, the network device can receive updated capability information from the terminal.

In some embodiments, the network device can determine that the terminal supports a target capability in the case where the capability information is not received. The target capability can include at least one of all-capability, weakest-capability, or strongest-capability.

From the above embodiments, the capability information received by the network device can include the first capability information, the second capability information, and the third capability information. If the network device does not receive the capability information from the terminal, the network device can estimate the target capability supported by the terminal, so that the transmission related to the low-power wake-up signal between the network device and the terminal can be carried out based on the target capability.

In some embodiments, if the network device does not receive the capability information, it is determined that the terminal supports all-capability, which can be all capabilities involved in the second capability information, the first capability information, and the third capability information. For example, the network device can determine that the terminal supports the Multi-Carrier On-Off Keying modulation, the Multi-Carrier Amplitude Shift Keying modulation, the Multi-Carrier Frequency Shift Keying modulation, the Phase Shift Keying modulation, and the Quadrature Amplitude modulation.

In some embodiments, if the network device does not receive the capability information, it is determined that the terminal supports strongest-capability, which can be the strongest capability among all capabilities involved in the second capability information, the first capability information, and the third capability information. For example, if the terminal supports the maximum quantity of modulation modes, then the capability of the terminal is determined to be the strongest. For example, if the time interval between the low-power synchronization signal and the low-power wake-up signal is the largest, then the capability of the terminal is determined to be the strongest. For example, if the number of low-power wake-up signals required to be received by the terminal to wake up the main radio is the least, that is, if one time-domain symbol carries the most information, then the capability of the terminal is determined to be the strongest.

In some embodiments, if the network device does not receive the capability information, it is determined that the terminal supports weakest-capability, which can be the weakest capability among all capabilities involved in the second capability information, the first capability information, and the third capability information. For example, if the terminal supports the minimum quantity of modulation modes, then the capability of the terminal is determined to be the weakest. For example, if the time interval between the low-power synchronization signal and the low-power wake-up signal is the smallest, then the capability of the terminal is determined to be the weakest. For example, if the number of low-power wake-up signals required to be received by the terminal to wake up the main radio is the most, that is, if one time-domain symbol carries the least information, then the capability of the terminal is determined to be the weakest.

In step S1420, a low-power wake-up signal is sent by the network device to the terminal based on the capability information.

In some embodiments, after receiving the capability information sent by the terminal, the network device can send the low-power wake-up signal based on the capability information. In some embodiments, the network device can send a certain number of low-power wake-up signals within the capability range of the terminal, and the capability range can be determined based on the capability information. For example, if the terminal needs to receive two low-power synchronization signals to wake up the main radio, then the network device can send one low-power wake-up signal to the terminal by considering the actual situation of the terminal.

In some embodiments, the network device can also send the low-power wake-up signal in a way that completely matches the capability information. For example, if the terminal needs to receive two low-power synchronization signals to wake up the main radio, then the network device can send two low-power synchronization signals to the terminal.

It should be noted that, as long as there is no contradiction, embodiments of the present disclosure can be combined with other embodiments or implementations and their various optional solutions, which are used for the terminal to report its capability, and will not be repeated here.

According to embodiments of the present disclosure, the network device can receive the capability information from the terminal, where the capability information is related to the low-power wake-up signal, so that the network device can be allowed to configure the low-power wake-up signal more reasonably.

FIG. 21 is a block diagram of a capability reporting apparatus 1500 according to embodiments of the present disclosure. As shown in FIG. 21, the capability reporting apparatus 1500 can include a sending module 1510.

The sending module 1510 is configured for the terminal to report capability information to the network device, which is related to the low-power wake-up signal.

In some embodiments, the capability information further includes first capability information, and the first capability information is configured to indicate at least one of following information:
a time interval between a synchronization field and a data field within the low-power wake-up signal;
a time interval between a low-power synchronization signal and the low-power wake-up signal;
a time interval between a reference field and the data field within the low-power wake-up signal;
a time interval between a low-power reference signal and the low-power wake-up signal;
the number of time-domain symbols occupied by the synchronization field of the low-power wake-up signal;
the number of time-domain symbols occupied by the low-power synchronization signal;
the number of time-domain symbols occupied by the reference field of the low-power wake-up signal;
the number of time-domain symbols occupied by the low-power reference signal.

In some embodiments, the time interval between the synchronization field and the data field within the low-power wake-up signal includes at least one of the following:
the number of symbols between a first/last time-domain symbol in the synchronization field and a first/last time-domain symbol in the data field;
the number of time slots between a time slot where the first/last time-domain symbol in the synchronization field is located and a time slot where the first/last time-domain symbol in the data field is located.

In some embodiments, the time interval between the low-power synchronization signal and the low-power wake-up signal includes at least one of the following:
the number of symbols between a first/last time-domain symbol of the low-power synchronization signal and a first/last time-domain symbol of the low-power wake-up signal;
the number of time slots between a time slot where the first/last time-domain symbol of the low-power synchronization signal is located and a time slot where the first/last time-domain symbol of the low-power wake-up signal is located.

In some embodiments, the time interval between the reference field and the data field within the low-power wake-up signal includes at least one of the following:
the number of symbols between a first/last time-domain symbol in the reference field and a first/last time-domain symbol in the data field;
the number of time slots between a time slot where the first/last time-domain symbol in the reference field is located and a time slot where the first/last time-domain symbol in the data field is located.

In some embodiments, the time interval between the low-power reference signal and the low-power wake-up signal includes at least one of the following:
the number of symbols between a first/last time-domain symbol of the low-power reference signal and a first/last time-domain symbol of the low-power wake-up signal;
the number of time slots between a time slot where the first/last time-domain symbol of the low-power reference signal is located and a time slot where the first/last time-domain symbol of the low-power wake-up signal is located.

In some embodiments, the time interval includes a minimum time interval, and/or the number of time-domain symbols includes a minimum number of time-domain symbols.

In some embodiments, the time interval is a fixed value, and/or the number of time-domain symbols is a fixed value.

In some embodiments, the capability information further includes second capability information, and the second capability information is configured to indicate a modulation mode of the low-power wake-up signal supported by the terminal.

In some embodiments, the modulation mode of the low-power wake-up signal supported by the terminal includes at least one of the following:
Multi-Carrier On-Off Keying modulation;
Multi-Carrier Amplitude Shift Keying modulation;
Multi-Carrier Frequency Shift Keying modulation;
Phase Shift Keying modulation;
Quadrature Amplitude modulation.

In some embodiments, the capability information further includes third capability information, and the third capability information is configured to indicate at least one of following information:
the number of low-power wake-up signals required to be received by the terminal to wake up a main radio;
the number of low-power synchronization signals required to be received by the terminal to wake up the main radio;
the number of low-power reference signals required to be received by the terminal to wake up the main radio;
the number of bits carried by one time-domain symbol of the low-power wake-up signal required to be received by the terminal to wake up the main radio;
the number of bits carried by two time-domain symbols of the low-power wake-up signal required to be received by the terminal to wake up the main radio.

In some embodiments, the sending module 1510 is further configured for the terminal to send updated capability information to the network device.

According to embodiments of the present disclosure, the terminal can report its capability information to the network device, where the capability information is related to the low-power wake-up signal, so that the network device can be allowed to configure the low-power wake-up signal more reasonably.

FIG. 22 is a block diagram of a capability reporting apparatus 1600 according to embodiments of the present disclosure. As shown in FIG. 22, the capability reporting apparatus 1600 can include a receiving module 1610 and a sending module 1620.

The receiving module 1610 is configured for a network device to receive capability information sent by a terminal, which is related to a low-power wake-up signal.

The sending module 1620 is configured for the network device to send the low-power wake-up signal to the terminal based on the capability information.

In some embodiments, the capability information further includes first capability information, and the first capability information is configured to indicate at least one of following information:
a time interval between a synchronization field and a data field within the low-power wake-up signal;
a time interval between a low-power synchronization signal and the low-power wake-up signal;
a time interval between a reference field and the data field within the low-power wake-up signal;
a time interval between a low-power reference signal and the low-power wake-up signal;
the number of time-domain symbols occupied by the synchronization field of the low-power wake-up signal;
the number of time-domain symbols occupied by the low-power synchronization signal;
the number of time-domain symbols occupied by the reference field of the low-power wake-up signal;
the number of time-domain symbols occupied by the low-power reference signal.

In some embodiments, the time interval between the synchronization field and the data field within the low-power wake-up signal includes at least one of the following:
the number of symbols between a first/last time-domain symbol in the synchronization field and a first/last time-domain symbol in the data field;
the number of time slots between a time slot where the first/last time-domain symbol in the synchronization field is located and a time slot where the first/last time-domain symbol in the data field is located.

In some embodiments, the time interval between the low-power synchronization signal and the low-power wake-up signal includes at least one of the following:
the number of symbols between a first/last time-domain symbol of the low-power synchronization signal and a first/last time-domain symbol of the low-power wake-up signal;
the number of time slots between a time slot where the first/last time-domain symbol of the low-power synchronization signal is located and a time slot where the first/last time-domain symbol of the low-power wake-up signal is located.

In some embodiments, the time interval between the reference field and the data field within the low-power wake-up signal includes at least one of the following:
the number of symbols between a first/last time-domain symbol in the reference field and a first/last time-domain symbol in the data field;
the number of time slots between a time slot where the first/last time-domain symbol in the reference field is located and a time slot where the first/last time-domain symbol in the data field is located.

In some embodiments, the time interval between the low-power reference signal and the low-power wake-up signal includes at least one of the following:
the number of symbols between a first/last time-domain symbol of the low-power reference signal and a first/last time-domain symbol of the low-power wake-up signal;
the number of time slots between a time slot where the first/last time-domain symbol of the low-power reference signal is located and a time slot where the first/last time-domain symbol of the low-power wake-up signal is located.

In some embodiments, the time interval includes a minimum time interval, and/or the number of time-domain symbols includes a minimum number of time-domain symbols.

In some embodiments, the time interval is a fixed value, and/or the number of time-domain symbols is a fixed value.

In some embodiments, the capability information further includes second capability information, and the second capability information is configured to indicate a modulation mode of the low-power wake-up signal supported by the terminal.

In some embodiments, the modulation mode of the low-power wake-up signal supported by the terminal includes at least one of the following:
Multi-Carrier On-Off Keying modulation;
Multi-Carrier Amplitude Shift Keying modulation;
Multi-Carrier Frequency Shift Keying modulation;
Phase Shift Keying modulation;
Quadrature Amplitude modulation.

In some embodiments, the capability information further includes third capability information, and the third capability information is configured to indicate at least one of following information:
the number of low-power wake-up signals required to be received by the terminal to wake up a main radio;
the number of low-power synchronization signals required to be received by the terminal to wake up the main radio;
the number of low-power reference signals required to be received by the terminal to wake up the main radio;
the number of bits carried by one time-domain symbol of the low-power wake-up signal required to be received by the terminal to wake up the main radio;
the number of bits carried by two time-domain symbols of the low-power wake-up signal required to be received by the terminal to wake up the main radio.

In some embodiments, the receiving module 1610 is further configured to receive updated capability information from the terminal.

In some embodiments, the capability reporting apparatus 1600 can further include a processing module configured to determine that the terminal supports a target capability, including at least one of all-capability, weakest-capability, or strongest-capability, in the case where the capability information is not received.

According to embodiments of the present disclosure, the network device can receive the capability information from the terminal, where the capability information is related to the low-power wake-up signal, so that the network device can be allowed to configure the low-power wake-up signal more reasonably.

Regarding the apparatus in the above embodiments, the specific ways in which each module performs operations have been described in detail in the relevant method embodiments, and will not be elaborated here.

The present disclosure also provides a communication system, which can include the terminal and the network device. The terminal is configured to perform operations related to the terminal, and the network device is configured to perform operations related to the network device.

The present disclosure also provides a computer-readable storage medium having computer program instructions stored thereon, when the computer program instructions are executed by a processor, steps of the capability reporting method provided in the present disclosure are executed.

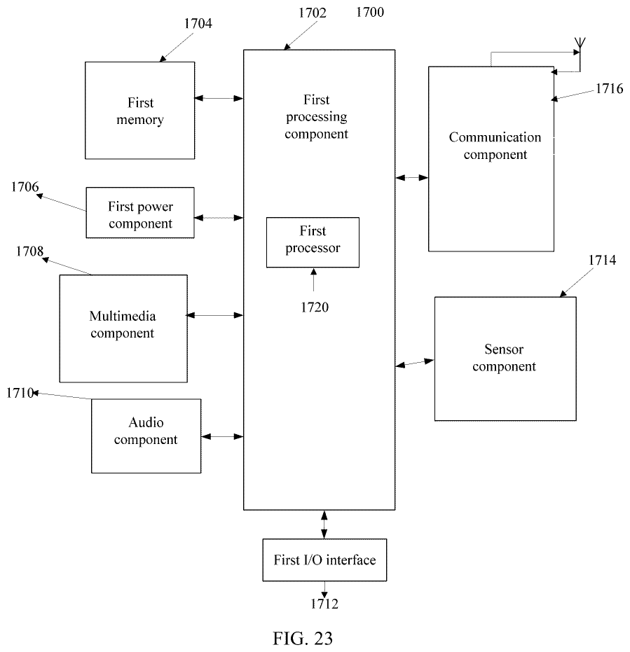

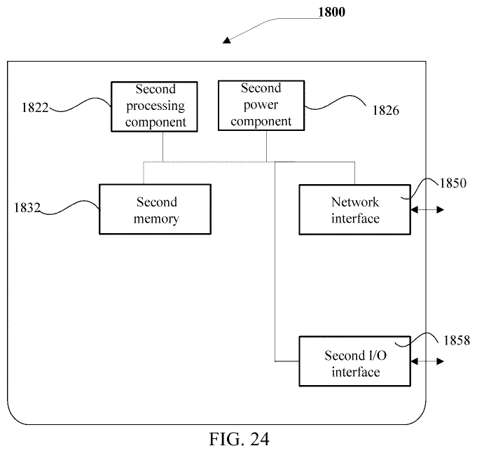

FIG. 23 is a block diagram of a terminal 1700 according to embodiments of the present disclosure. For example, the terminal 1700 can be a mobile phone, a computer, a digital broadcasting user device, a messaging device, a game console, a tablet device, a medical device, a fitness device, a personal digital assistant, etc.

As shown in FIG. 23, the terminal 1700 can include one or more following components: a first processing component 1702, a first memory 1704, a first power component 1706, a multimedia component 1708, an audio component 1710, a first input/output (I/O) interface 1712, a sensor component 1714, and a communication component 1716.

The first processing component 1702 typically controls the overall operation of the terminal 1700, such as operations associated with display, telephone call, data communication, camera operation, and recording operations. The first processing component 1702 can include one or more processors to execute instructions to complete all or part of the above capability reporting method. In addition, the first processing component 1702 can include one or more modules to facilitate interactions between the first processing component 1702 and other components. For example, the first processing component 1702 can include a multimedia module to facilitate the interaction between the multimedia component 1708 and the first processing component 1702.

The first memory 1704 is configured to store various types of data to support operations on the terminal 1700. Examples of such data include instructions, contact data, phone book data, messages, pictures, videos, and the like for any application or method operating on the terminal 1700. The first memory 1704 can be implemented by any type of volatile or non-volatile storage device or their combinations, such as static random access memory (SRAM), electrically erasable programmable read-only memory (EEPROM), erasable programmable read-only memory (EPROM), programmable read-only memory (PROM), read-only memory (ROM), magnetic memory, flash memory, disk or optical disk.

The first power component 1706 provides power for various components of the terminal 1700. The first power component 1706 can include a power management system, one or more power supplies, and other components associated with generating, managing, and distributing power for the terminal 1700.

The multimedia component 1708 includes a display screen providing an output interface between the terminal 1700 and the user. In some embodiments, the screen may include a liquid crystal display (LCD) and a touch panel (TP). If the screen includes a touch panel, the screen can be implemented as a touch screen to receive input signals from the user. The touch panel includes one or more touch sensors to sense touch, sliding, and gestures on the touch panel. The touch sensor can not only sense the boundaries of touch or sliding actions, but also detect the duration and pressure related to the touch or sliding operation. In some embodiments, the multimedia component 1708 includes a front camera and/or a rear camera. When the terminal 1700 is in operation mode, such as shooting mode or video mode, the front camera and/or rear camera can receive external multimedia data. Each front camera and rear camera can be a fixed optical lens system or have focal length and optical zoom capability.

The audio component 1710 is configured to output and/or input audio signals. For example, the audio component 1710 includes a microphone (MIC), which is configured to receive an external audio signal when the terminal 1700 is in an operation mode, such as a calling mode, a recording mode, and a voice recognition mode. The received audio signal may be further stored in first memory 1704 or transmitted via communication component 1716. In some embodiments, the audio component 1710 also includes a speaker for outputting audio signals.

The first input/output (I/O) interface 1712 provides an interface between the first processing component 1702 and peripheral interface modules, which can be a keyboard, a click wheel, a button, etc. These buttons may include, but are not limited to, the Home button, the Volume button, the Start button, and the Lock button.

The sensor component 1714 includes one or more sensors for providing various aspects of condition evaluation for the terminal 1700. For example, the sensor component 1714 can detect an open/closed state of the terminal 1700, relative positioning of the components. The component is, for example, a display and a keypad of the terminal 1700. The sensor component 1714 can also detect changes in the position of the terminal 1700 or one component of the terminal 1700, presence or absence of the user's contact with the terminal 1700, orientation or acceleration/deceleration of the terminal 1700 and temperature change of the terminal 1700. The sensor component 1714 may include a proximity sensor configured to detect the presence of nearby objects without any physical contact. The sensor component 1714 may also include a light sensor, such as a CMOS or CCD image sensor, for use in imaging applications. In some embodiments, the sensor component 1714 may also include an acceleration sensor, a gyroscope sensor, a magnetic sensor, a pressure sensor, or a temperature sensor.

The communication component 1716 is configured to facilitate wired or wireless communication between the terminal 1700 and other devices. The terminal 1700 can access wireless networks based on communication standards, such as WiFi, 2G or 3G, or a combination thereof. In some embodiments, the communication component 1716 receives a broadcast signal or broadcast related information from an external broadcast management system via a broadcast channel. In some embodiments, the communication component 1716 also includes a near field communication (NFC) module to facilitate short range communication. For example, the NFC module can be implemented based on radio frequency identification (RFID) technology, infrared data association (IrDA) technology, ultra wideband (UWB) technology, Bluetooth (BT) technology and other technologies.

In some embodiments, the terminal 1700 can be implemented through one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components, for implementing the above capability reporting method.

In some embodiments, a non-transitory computer-readable storage medium including instructions is also provided, such as a first memory 1704 including instructions, which can be executed by the first processor 1720 of the terminal 1700 to complete the above capability reporting method. For example, the non-transitory computer-readable storage medium can be ROM, random access memory (RAM), CD-ROM, tapes, floppy disks, optical data storage devices, etc.

The above device can not only be an independent electronic device, but also a part of an independent electronic device. For example, in some embodiments, the device can be an integrated circuit (IC) or a chip, where the integrated circuit can be one IC or a collection of multiple ICs. The chip can include but is not limited to the following types: GPU (Graphics Processing Unit), CPU (Central Processing Unit), FPGA (Field Programmable Gate Array), DSP (Digital Signal Processor), ASIC (Application Specific Integrated Circuit), SOC (System on Chip, SoC, System-on-Chip or System-level Chip), etc. The above integrated circuits or chips can be used to execute executable instructions (or codes) to achieve the above capability reporting method. The executable instructions can be stored in the integrated circuit or chip, or obtained from other devices or equipment, for example, the integrated circuit or chip includes the processor, the memory, and interfaces for communication with other devices. The executable instruction can be stored in the memory, and the above capability reporting method can be implemented when the executable instruction is executed by the processor. Alternatively, the integrated circuit or chip can receive executable instructions through the interface and transmit them to the processor for execution, in order to achieve the above capability reporting method.

Embodiments of the present disclosure also provide a computer program product including a computer program executable by a programmable device, the computer program having a code portion for executing the above capability reporting method when executed by the programmable device.

FIG. 24 is a block diagram of a network device according to embodiments of the present disclosure. For example, the network device 1800 can be provided as a server. The network device can include an access network device and a core network device. As shown in FIG. 24, the network device 1800 includes a second processing component 1822, which further includes one or more second processors, and a second memory 1832, which represents the memory resources and is configured for storing instructions that can be executed by the second processing component 1822, such as application programs. The application programs stored in the second memory 1832 may include one or more modules each corresponding to a set of instructions. In addition, the second processing component 1822 is configured to execute the instructions to perform the above capability reporting method.

The network device 1800 may further include a second power component 1826 configured to perform the power management for the network device 1800, a wired or wireless network interface 1850 configured to connect the network device 1800 to the network, and a second input/output (I/O) interface 1858. The network device 1800 can be operated based on an operating system stored in the second memory 1832, such as Windows Server™, Mac OS X™, Unix™, Linux™, FreeBSD™, or similar operating systems.

After considering the specification and practices of the invention disclosed herein, those skilled in the art will easily come up with other implementation solutions of the present disclosure. The present disclosure intends to cover any variations, uses, or adaptive changes of the present disclosure, which follow the general principles of the present disclosure and include common knowledge or commonly used technical means in the art that are not disclosed in the present disclosure. The specification and embodiments are only considered as exemplary, and the true scope and spirit of the present disclosure are defined by appended claims.

It should be understood that embodiments of the present disclosure are not limited to the precise structure described in the above and shown in the drawings, and various modifications and changes can be made without departing from its scope. The scope of the present disclosure is limited only by the appended claims.

1. A capability reporting method, comprising:
reporting, by a terminal, capability information to a network device, wherein the capability information is related to a low-power wake-up signal.

2. The method according to claim 1, wherein the capability information comprises first capability information, and the first capability information is configured to indicate at least one of following information:
a time interval between a synchronization field and a data field within the low-power wake-up signal;
a time interval between a low-power synchronization signal and the low-power wake-up signal;
a time interval between a reference field and the data field within the low-power wake-up signal;
a time interval between a low-power reference signal and the low-power wake-up signal;
a number of time-domain symbols occupied by the synchronization field of the low-power wake-up signal;
a number of time-domain symbols occupied by the low-power synchronization signal;
a number of time-domain symbols occupied by the reference field of the low-power wake-up signal; or
a number of time-domain symbols occupied by the low-power reference signal.

3. The method according to claim 2, wherein the time interval between the synchronization field and the data field within the low-power wake-up signal comprises at least one of:
a number of symbols between a first time-domain symbol in the synchronization field and a first time-domain symbol or a last time-domain symbol in the data field;
a number of symbols between a last time-domain symbol in the synchronization field and the first time-domain symbol or the last time-domain symbol in the data field;
a number of time slots between a time slot where the first time-domain symbol in the synchronization field is located and a time slot where the first time-domain symbol or the last time-domain symbol in the data field is located; or
a number of time slots between a time slot where the last time-domain symbol in the synchronization field is located and the time slot where the first time-domain symbol or the last time-domain symbol in the data field is located.

4. The method according to claim 2, wherein the time interval between the low-power synchronization signal and the low-power wake-up signal comprises at least one of:
a number of symbols between a first time-domain symbol of the low-power synchronization signal and a first time-domain symbol or a last time-domain symbol of the low-power wake-up signal;
a number of symbols between a last time-domain symbol of the low-power synchronization signal and the first time-domain symbol or the last time-domain symbol of the low-power wake-up signal;
a number of time slots between a time slot where the first time-domain symbol of the low-power synchronization signal is located and a time slot where the first time-domain symbol or the last time-domain symbol of the low-power wake-up signal is located; or
a number of time slots between a time slot where the last time-domain symbol of the low-power synchronization signal is located and the time slot where the first time-domain symbol or the last time-domain symbol of the low-power wake-up signal is located.

5. The method according to claim 2, wherein the time interval between the reference field and the data field within the low-power wake-up signal comprises at least one of:
a number of symbols between a first time-domain symbol in the reference field and a first time-domain symbol or a last time-domain symbol in the data field;
a number of symbols between a last time-domain symbol in the reference field and the first time-domain symbol or the last time-domain symbol in the data field;
a number of time slots between a time slot where the first time-domain symbol in the reference field is located and a time slot where the first time-domain symbol or the last time-domain symbol in the data field is located; or
a number of time slots between a time slot where the last time-domain symbol in the reference field is located and the time slot where the first time-domain symbol or the last time-domain symbol in the data field is located.

6. The method according to claim 2, wherein the time interval between the low-power reference signal and the low-power wake-up signal comprises at least one of:
a number of symbols between a first time-domain symbol of the low-power reference signal and a first time-domain symbol or a last time-domain symbol of the low-power wake-up signal;
a number of symbols between a last time-domain symbol of the low-power reference signal and the first time-domain symbol or the last time-domain symbol of the low-power wake-up signal;
a number of time slots between a time slot where the first time-domain symbol of the low-power reference signal is located and a time slot where the first time-domain symbol or the last time-domain symbol of the low-power wake-up signal is located; or
a number of time slots between a time slot where the last time-domain symbol of the low-power reference signal is located and the time slot where the first time-domain symbol or the last time-domain symbol of the low-power wake-up signal is located.

7.-8. (canceled)

9. The method according to claim 1, wherein the capability information further comprises second capability information, and the second capability information is configured to indicate a modulation mode of the low-power wake-up signal supported by the terminal.

10. The method according to claim 9, wherein the modulation mode of the low-power wake-up signal supported by the terminal comprises at least one of:
Multi-Carrier On-Off Keying modulation;
Multi-Carrier Amplitude Shift Keying modulation;
Multi-Carrier Frequency Shift Keying modulation;
Phase Shift Keying modulation; or
Quadrature Amplitude modulation.

11. The method according to claim 1, wherein the capability information further comprises third capability information, and the third capability information is configured to indicate at least one of following information:
a number of low-power wake-up signals required to be received by the terminal to wake up a main radio;
a number of low-power synchronization signals required to be received by the terminal to wake up the main radio;
a number of low-power reference signals required to be received by the terminal to wake up the main radio;
a number of bits carried by one time-domain symbol of the low-power wake-up signal required to be received by the terminal to wake up the main radio; or
a number of bits carried by two time-domain symbols of the low-power wake-up signal required to be received by the terminal to wake up the main radio.

12. The method according to claim 1, further comprising:
sending, by the terminal, updated capability information to the network device.

13. A capability reporting method, comprising:
receiving, by a network device, capability information sent by a terminal, wherein the capability information is related to a low-power wake-up signal; and
sending, by the network device, the low-power wake-up signal to the terminal based on the capability information.

14. The method according to claim 13, wherein the capability information comprises first capability information, and the first capability information is configured to indicate at least one of following information:
a time interval between a synchronization field and a data field within the low-power wake-up signal;
a time interval between a low-power synchronization signal and the low-power wake-up signal;
a time interval between a reference field and the data field within the low-power wake-up signal;
a time interval between a low-power reference signal and the low-power wake-up signal;
a number of time-domain symbols occupied by the synchronization field of the low-power wake-up signal;
a number of time-domain symbols occupied by the low-power synchronization signal;
a number of time-domain symbols occupied by the reference field of the low-power wake-up signal; or
a number of time-domain symbols occupied by the low-power reference signal.

15. The method according to claim 14, wherein at least one of:
wherein the time interval between the synchronization field and the data field within the low-power wake-up signal comprises at least one of:
a number of symbols between a first time-domain symbol in the synchronization field and a first time-domain symbol or a last time-domain symbol in the data field;
a number of symbols between a last time-domain symbol in the synchronization field and the first time-domain symbol or the last time-domain symbol in the data field;
a number of time slots between a time slot where the first time-domain symbol in the synchronization field is located and a time slot where the first time-domain symbol or the last time-domain symbol in the data field is located; or
a number of time slots between a time slot where the last time-domain symbol in the synchronization field is located and the time slot where the first time-domain symbol or the last time-domain symbol in the data field is located;
wherein the time interval between the low-power synchronization signal and the low-power wake-up signal comprises at least one of:
a number of symbols between a first time-domain symbol of the low-power synchronization signal and a first time-domain symbol or a last time-domain symbol of the low-power wake-up signal;
a number of symbols between a last time-domain symbol of the low-power synchronization signal and the first time-domain symbol or the last time-domain symbol of the low-power wake-up signal;
a number of time slots between a time slot where the first time-domain symbol of the low-power synchronization signal is located and a time slot where the first time-domain symbol or the last time-domain symbol of the low-power wake-up signal is located; or
a number of time slots between a time slot where the last time-domain symbol of the low-power synchronization signal is located and the time slot where the first time-domain symbol or the last time-domain symbol of the low-power wake-up signal is located;
wherein the time interval between the reference field and the data field within the low-power wake-up signal comprises at least one of:
a number of symbols between a first time-domain symbol in the reference field and a first time-domain symbol or a last time-domain symbol in the data field;
a number of symbols between a last time-domain symbol in the reference field and the first time-domain symbol or the last time-domain symbol in the data field;
a number of time slots between a time slot where the first time-domain symbol in the reference field is located and a time slot where the first time-domain symbol or the last time-domain symbol in the data field is located; or
a number of time slots between a time slot where the last time-domain symbol in the reference field is located and the time slot where the first time-domain symbol or the last time-domain symbol in the data field is located;
or wherein the time interval between the low-power reference signal and the low-power wake-up signal comprises at least one of:
a number of symbols between a first time-domain symbol of the low-power reference signal and a first time-domain symbol or a last time-domain symbol of the low-power wake-up signal;
a number of symbols between a last time-domain symbol of the low-power reference signal and the first time-domain symbol or the last time-domain symbol of the low-power wake-up signal;
a number of time slots between a time slot where the first time-domain symbol of the low-power reference signal is located and a time slot where the first time-domain symbol or the last time-domain symbol of the low-power wake-up signal is located; or
a number of time slots between a time slot where the last time-domain symbol of the low-power reference signal is located and the time slot where the first time-domain symbol or the last time-domain symbol of the low-power wake-up signal is located.

16.-20. (canceled)

21. The method according to claim 13, wherein the capability information further comprises second capability information, and the second capability information is configured to indicate a modulation mode of the low-power wake-up signal supported by the terminal.

22. The method according to claim 21, wherein the modulation mode of the low-power wake-up signal supported by the terminal comprises at least one of:
Multi-Carrier On-Off Keying modulation;
Multi-Carrier Amplitude Shift Keying modulation;
Multi-Carrier Frequency Shift Keying modulation;
Phase Shift Keying modulation; or
Quadrature Amplitude modulation.

23. The method according to claim 13, wherein the capability information further comprises third capability information, and the third capability information is configured to indicate at least one of following information:
a number of low-power wake-up signals required to be received by the terminal to wake up a main radio;
a number of low-power synchronization signals required to be received by the terminal to wake up the main radio;
a number of low-power reference signals required to be received by the terminal to wake up the main radio;
a number of bits carried by one time-domain symbol of the low-power wake-up signal required to be received by the terminal to wake up the main radio; or
a number of bits carried by two time-domain symbols of the low-power wake-up signal required to be received by the terminal to wake up the main radio.

24. The method according to claim 13, further comprising:
receiving updated capability information from the terminal.

25.-26. (canceled)

27. A terminal, comprising:
a first processor; and
a first memory configured to store executable instructions for the first processor;
wherein the first processor is configured to execute the executable instructions to perform the method according to claim 1.

28. A network device, comprising:
a second processor; and
a second memory configured to store executable instructions for the second processor;
wherein the second processor is configured to execute the executable instructions to perform the method according to claim 13.

29. (canceled)

30. A non-transitory computer-readable storage medium having computer program instructions stored thereon, which when executed by a processing device, steps of the method according to claim 1 is caused to be implemented.
